(19) United States
(12) Patent Application Publication
(10) Pub. No.: US 2014/0175104 A1
(43) Pub. Date: Jun. 26, 2014

(54) PAINT BUCKET COVER

(71) Applicant: KOVRD PRODUCTS INC., Calgary (CA)

(72) Inventors: Benjamin LEONARD, Calgary (CA); Vance Macdonald, Calgary (CA)

(73) Assignee: KOVRD PRODUCTS INC., Calgary (CA)

(21) Appl. No.: 14/136,619

(22) Filed: Dec. 20, 2013

Related U.S. Application Data
(60) Provisional application No. 61/745,028, filed on Dec. 21, 2012.

(51) Int. Cl. B44D 3/12

(52) U.S. Cl. CPC B44D 3/127
USPC 220/735

(57) ABSTRACT

An apparatus that is generally directed to a paint bucket cover, and specifically to a sealable paint bucket cover comprising structures to securely hold painting tools such as rollers or brushes within the container when the cover is in place, is provided. When not being accessed, paint containers need to be sealed to keep the contents from spilling, or the paint from drying out. Frequently, however, it desirable to be able to cover a paint container while painting tools are still in the bucket. The cover includes a panel comprised of at least a first surface and a paint tool holder, and a band for releasably connecting the cover to the paint container while creating a substantially air-tight configuration.

### FIELD OF THE INVENTION

The present invention is directed generally to a paint container cover and specifically to a sealable paint container cover comprising structures to securely hold painting tools such as rollers or brushes within the container when the cover is in place on the paint container.

### BACKGROUND

Containers for storing paint have been in use for many years. When not being accessed, these containers need to be sealed to keep the contents from spilling, or the paint from drying out. The original container lid that is supplied when the container is shipped can be difficult to open and close, and may require tools to attach and remove the lid. Paint container lids are also problematic when the lid or the receiving rim of the container becomes covered in paint causing the lid to become stuck. This can be very inconvenient and time consuming when the container must be accessed sporadically, but repeatedly. It is also common that painters must leave a painting job partially done, whether for a break or at the end of the work day. Under these circumstances, the painter must cover the paint container and clean the painting tools so that they are paint free in order to prevent the paint from drying in the brush, roller or paint sprayer rendering them unusable. Covering paint containers and cleaning tools in this conventional manner is time consuming, messy, and inconvenient for the painter.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1a is a schematic view of a first embodiment of the invention in an open state.

FIG. 1b is a schematic view of a first embodiment of the invention in a closed state.

FIG. 2 is a schematic view of the cover of FIGS. 1a and 1b showing it installed on a paint container.

FIG. 3a is a schematic view of an alternate embodiment of the invention showing two paint brush holders.

FIG. 3b is a schematic view of the embodiment of FIG. 3a in an open state showing a secured paint brush.

FIG. 4 is a schematic view of the cover of FIGS. 3a and 3b showing the alternate embodiment installed on a paint container with a secured paint roller and brushes.

FIG. 5 is a schematic view of a further embodiment of the invention showing a cinchable sleeve and aperture for receiving a paint roller.

FIG. 6 is a schematic view of a further embodiment of the invention showing a panel configured for receiving a paint roller.

FIG. 7 is a schematic view of a further embodiment of the invention showing a panel configured for receiving a paint roller.

FIG. 8 is a schematic view of a further embodiment of the invention showing a panel configured for receiving a paint roller.

FIG. 9 is a schematic view of a further embodiment of the invention showing a panel configured for receiving a paint roller.

FIG. 10a is a of a further embodiment of the invention showing a securable flap allowing access to the interior space of an enclosed paint container, including a sealable aperture configured to accommodate painting tools and a seam joining the aperture to the distal edge of the band.

FIG. 10b is an alternate drawing of the embodiment of FIG. 17a showing the flap and seam sealed.

FIG. 10c is an alternate drawing of the embodiment of FIGS. 17a and 17b showing the seam sealed and the flap partially open.

FIG. 11a is a drawing of a further embodiment of the invention showing a snap fastening mechanism in a closed position.

FIG. 11b is a drawing showing the alternate view of the embodiment of FIG. 11a with the snap fastening mechanism in an open position.

FIG. 12a is a drawing of a further embodiment of the invention showing a flap and aperture that extend to the distal edge of the band in a closed position.

FIG. 12b is a drawing of the embodiment of FIG. 12a showing a flap and aperture that extend to the distal edge of the band in an open position.

FIG. 12c is a drawing of the embodiment of FIG. 12a showing a flap and aperture that extend to the distal edge of the band in a partially closed position as it would appear if components of a painting tool (not shown) were present.

FIG. 13a is a drawing of the embodiment of FIG. 12a attached to a paint bucket in a closed position without a protruding painting tool.

FIG. 13b is a drawing of the embodiment of FIG. 12a attached to a paint bucket in an open position with a protruding painting tool.

FIG. 13c is a drawing of the embodiment of FIG. 12a attached to a paint bucket in a partially closed position with a protruding painting tool.

### DETAILED DESCRIPTION OF THE INVENTION

In describing the components of the paint bucket cover and alternative versions or embodiments of some of these components, the same reference number may be used for elements that are the same as, or similar to, elements described in other versions or embodiments.

The cover 10 of the present invention can be attached to any paint container 100 having a size and shape corresponding to the cover 10. For the purposes of the present description, the cover is shown as a generally circular cover for a cylindrical 5-gallon paint container 100, but the novel features described herein can correspond to a cover 10 of any reasonable size and shape.

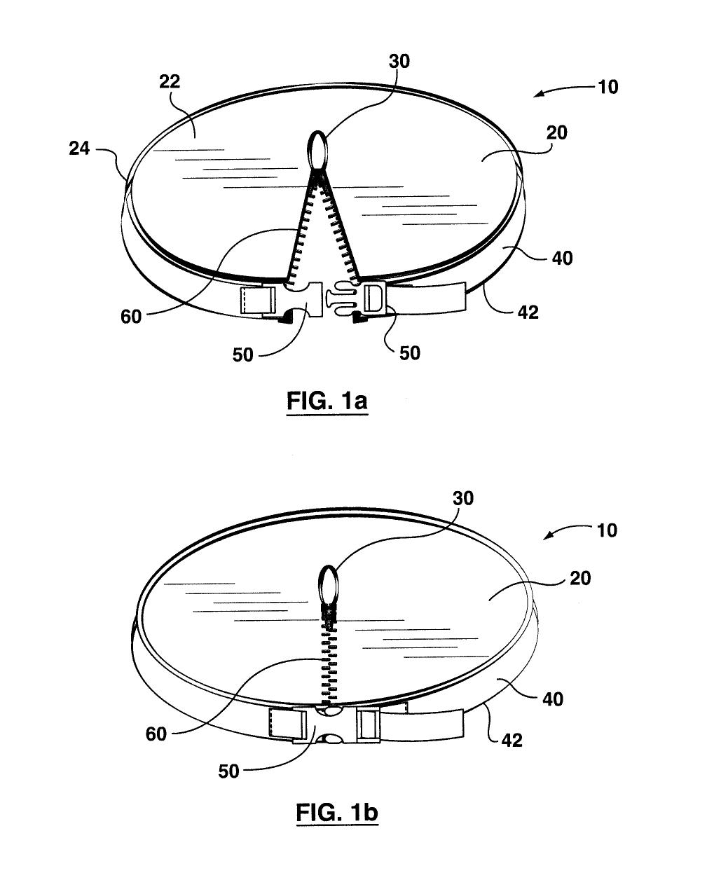

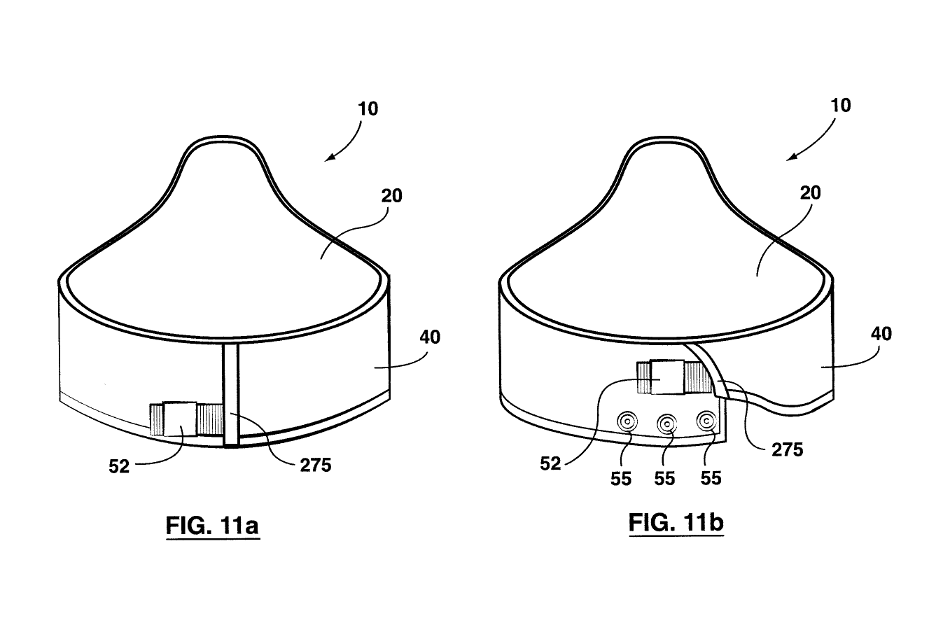

Referring now to FIGS. 1a and 1b, a cover according to the present invention is illustrated generally at 10. The cover 10 comprises a panel 20, which in turn comprises a first surface 22. The panel 20 has a continuous edge 24. In this exemplary embodiment, the first surface 22 further comprises at least one tool holder 30. Connected to the continuous edge 24, is a band 40 having a distal edge 42. The cover 10 and the band 40 are sized to cover the opening and envelop the rim respectively of the paint container 100 to be sealed. In this embodiment, the band 40 is flexible, and connected to the band 40 is a fastening mechanism 50 for cinching the band 40 into a substantially air-tight configuration on the paint container 100. Alternatively, the band 40 or the continuous edge 24 may be elastic and inherently capable of providing a flexible, substantially air-tight seal on the paint container 100 without the need of a fastening mechanism 50 for cinching. Further, the band 40 may be inelastic and rigid, and configured to fixably mate with the rim or sides of the paint container 100. With reference to FIGS. 11a and 11b, there is also shown an additional embodiment of the fastening mechanism 50 comprising a female snap attachment 52 and at least one, and preferably several, male snap locations 55 spaced and registered so that the band 40 can be secured to paint containers 100 of various sizes. Preferably the one or more male snap locations 55 will be placed to use the natural elasticity of the band 40, for cinching the cover 10 so that it is firmly affixed to the paint container 100 in a substantially air tight configuration.

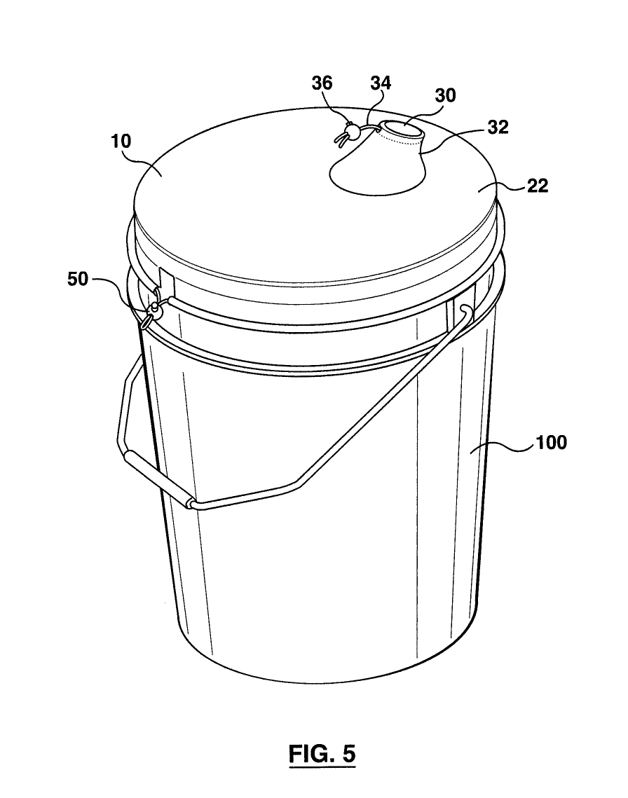

In FIGS. 1a and 1b, the tool holder 30 is shown as an aperture in the first surface 22 that is sized to receive the handle of a standard paint roller 110, which may include any standard fittings and roller accessories known in the art such as extension rods or metal dowel-like rods that connect a roller handle 110 and a roller cage. The aperture is configured to maintain a substantially air-tight seal when in the closed state as in FIG. 1b, while being flexible to accommodate the roller handle 110. Preferably, the aperture is lined with a rubber or rubber-like material to resiliently grip the roller handle 110, but it will be appreciated by those skilled in the art that alternate means are available to create a seal for mateably engaging with a painting tool that may be employed without deviating from the spirit and scope of the invention. In the exemplary embodiment, the fastening mechanism 50 is depicted as a buckle and strap assembly connected to the band 40. It will be appreciated that many alternate fastening assemblies known in the art may be used so that when the fastening mechanism 50 is in a closed and secured position, band 40 is pulled tightly around the circumference of the paint container 100 in a cinched configuration. For example, the band 40 may be configured to accept a flexible cord that is releasable engaged by a lockable clasp as depicted in FIG. 5. Also, as described above and shown in FIGS. 11a and 11b, the fastening mechanism 50 may include snaps.

Optionally, FIGS. 1a and 1b also depict a slit 60 that extends from the tool holder 30 to the distal edge 42 of the band 40 to assist in the installation and removal of the cover 10 from the paint container 100. In the exemplary embodiment, the slit is depicted with a zipper as a sealing mechanism for the slit 60, but it will also be appreciated by those skilled in the art that alternate means of providing a substantially air-tight seal such as hook and loop fasteners or snaps may be used.

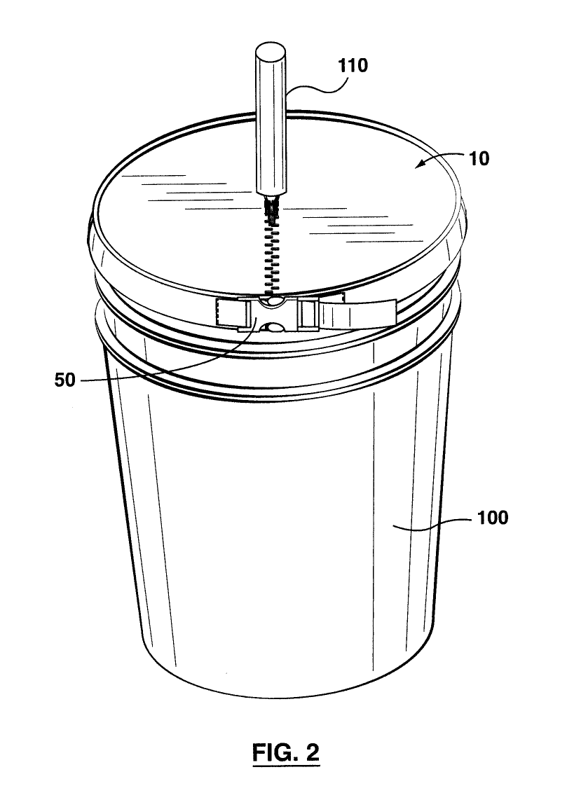

Referring to FIG. 2, there is shown a cover 10 installed on a paint container 100, with a roller handle 110 being supported, whereby the paint container 100 is substantially sealed in an air-tight manner and the roller is suspended in the substantially air-tight environment or immersed in the paint, thereby alleviating the need to immediately clean the roller in order to pause during painting. To remove the cover 10, a painter would undo the fastening mechanism 50 and open the slit 60 in order to free the roller handle 110 and release the cover 10 from its mating engagement with the paint container 100. To re-install, a painter would reverse the process.

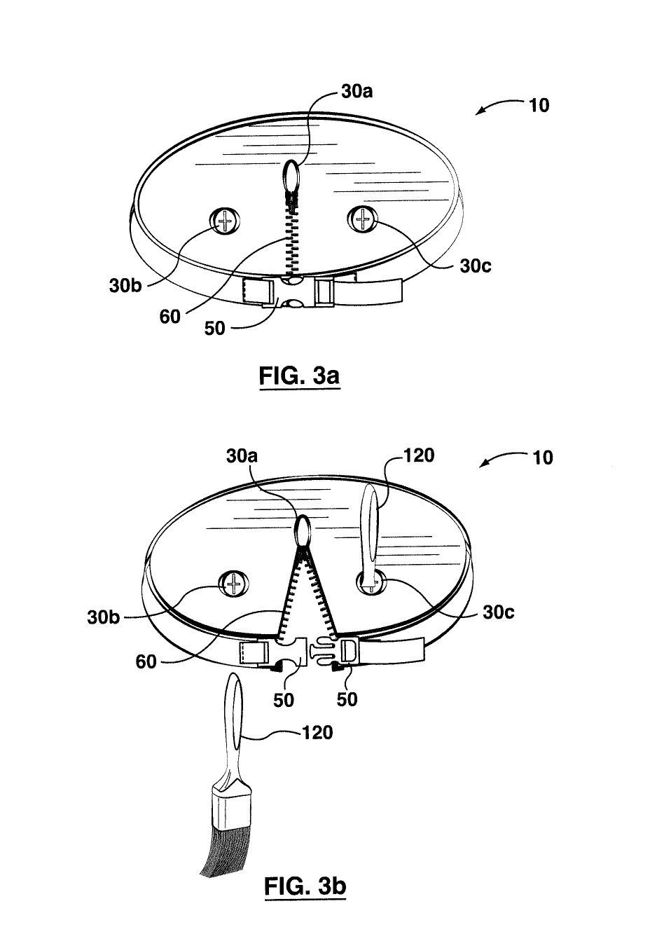

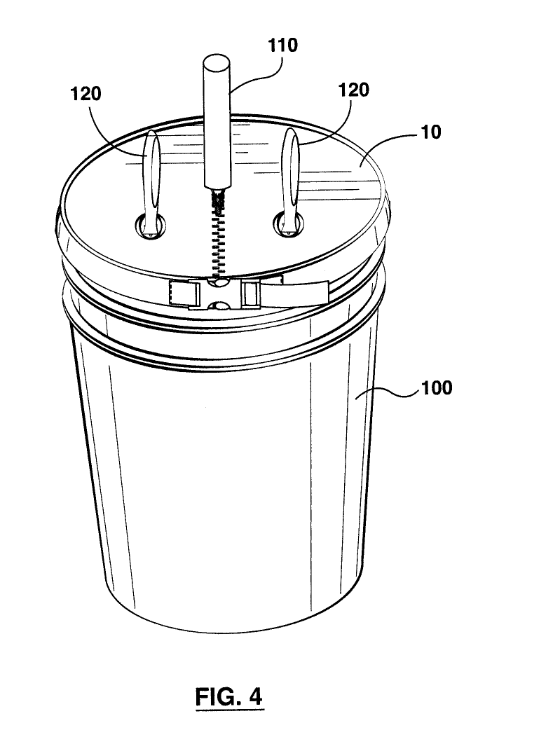

An alternate embodiment of the present invention is shown in FIGS. 3a and 3b, wherein the first surface 22 is configured with multiple tool holders 30a-c. In this case, tool holders 30b and 30c are configured to slideably receive paint brush handles 120, providing sufficient grip to support the weight of the brush. Preferably the tool holders 30b,c may be comprised of apertures in the first surface 22 that are filled with a flexible gripping material having a second void or one or more slits. This flexible gripping material may be rubber or a rubber like substance, but variations known in the art may also be used. The flexible gripping material is allows for the insertion of a brush handle 120 into the aperture and corresponding slit, thereby enveloping the brush handle 120 once inserted and keeping air out of the paint container 100. When a brush handle 120 is not inserted into a tool holder 30b,c, the slit or other aperture structure of the tool holder 30b,c remains in a closed configuration to keep air out. FIG. 4 shows the cover 10 in use with a paint container 100, supporting a roller handle 110 in tool holder 30a, and two brush handles 120 in tool holders 30b,c.

In FIG. 5 there is shown a further embodiment of the present invention. In this embodiment, the tool holder 30 is configured as a sleeve 32 that mates with the first surface 22. The distal end of the sleeve 32 has an aperture that communicates through the sleeve 32 with the interior of the paint container 100 when the cover 10 is installed, and is sized to receive the handles of standard painting tools such as that of a paint roller 110. Proximate the distal end of the sleeve 32 and connected to it there there is shown a draw string 34 and a lockable tie 36 that cooperate to cinch the sleeve 32 around the handle of a painting tool. Also shown is an alternate fastening mechanism 50 that operates similarly to the combination of the draw string 34 and the lockable tie 36. It will be appreciated by one skilled in the art that other means of encouraging and maintaining a desired seal may optionally be used without derogating from the spirit and scope of the invention.

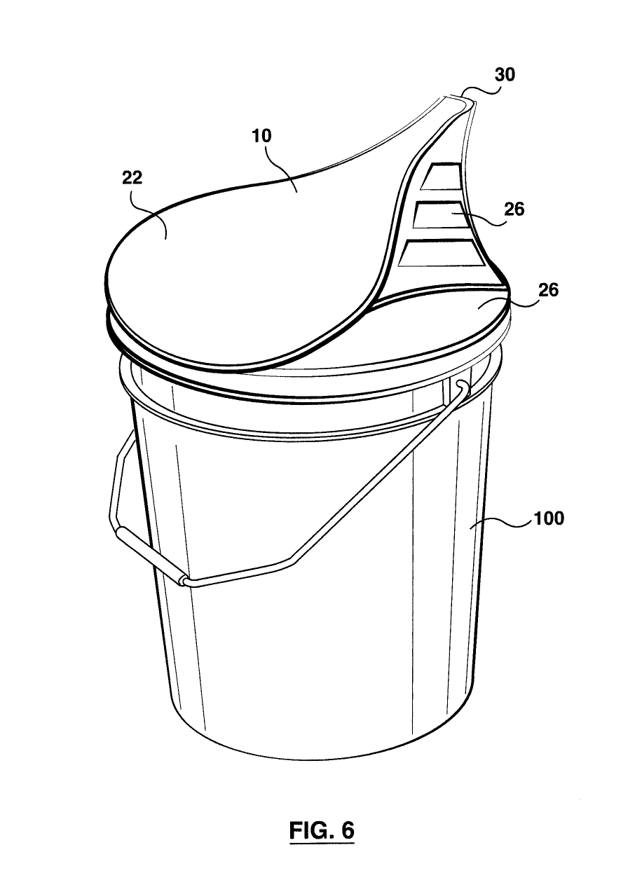

FIG. 6 shows a further embodiment of the invention where the panel 20 comprises the first surface 22 mated with one or more sheets 26 to create a dome-shaped protrusion sized to accommodate a painting tool such as a paint roller when it is placed in the paint container 100 with the cover 10 attached. In this embodiment, the tool holder 30 is comprised of a restriction in the dome-shaped protrusion that accommodates the painting tool inside the paint container 100 and restrains the painting tool from excessive movement and maintains its orientation with in the paint container 100.

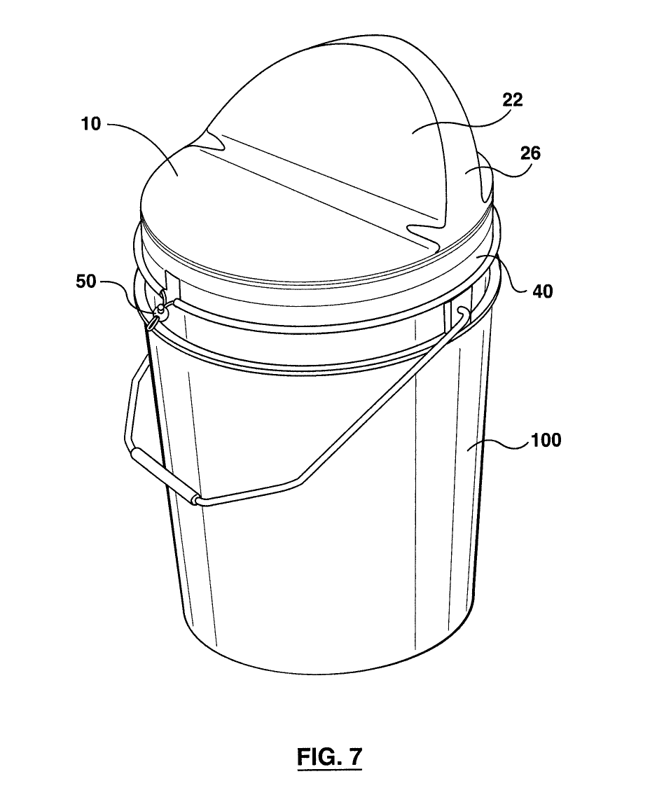

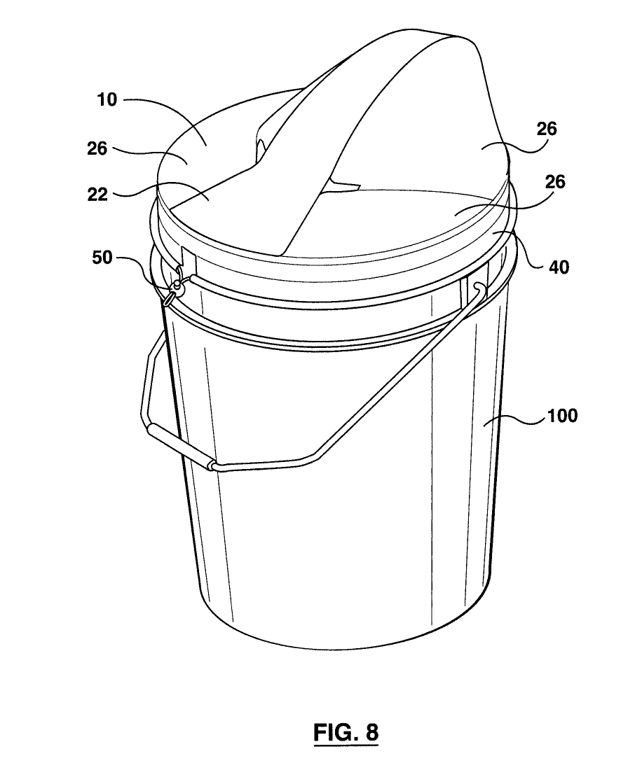

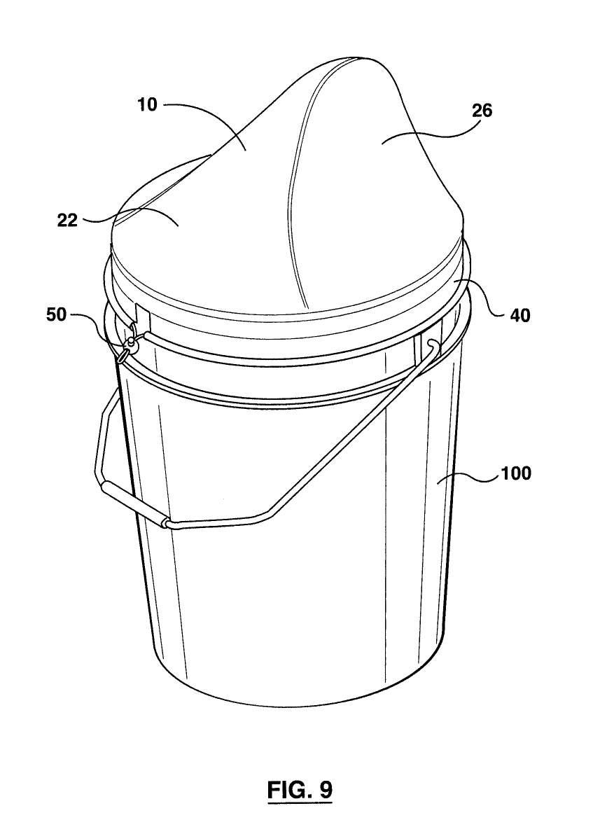

FIGS. 7-9 show further embodiments of the invention similar to that depicted in FIG. 6. In each case, one or more sheets 26 are connected to the first surface 22 to create a dome-shaped protrusion sized to accommodate a painting tool. These, and the embodiment shown in FIG. 6, are particularly advantageous when the painting tool, such as a paint roller, is attached to a painters screen or grid inside the paint container 100. In such circumstances, the cover 10 allows for greater tolerance for where the roller handle 110 is positioned and therefore does not require fine precision during the installation of the cover 10. It will be appreciated by those skilled in the art that other arrangements and orientations of the first surface 22 and one or more sheets 26 may be adopted that are also within the scope of this invention.

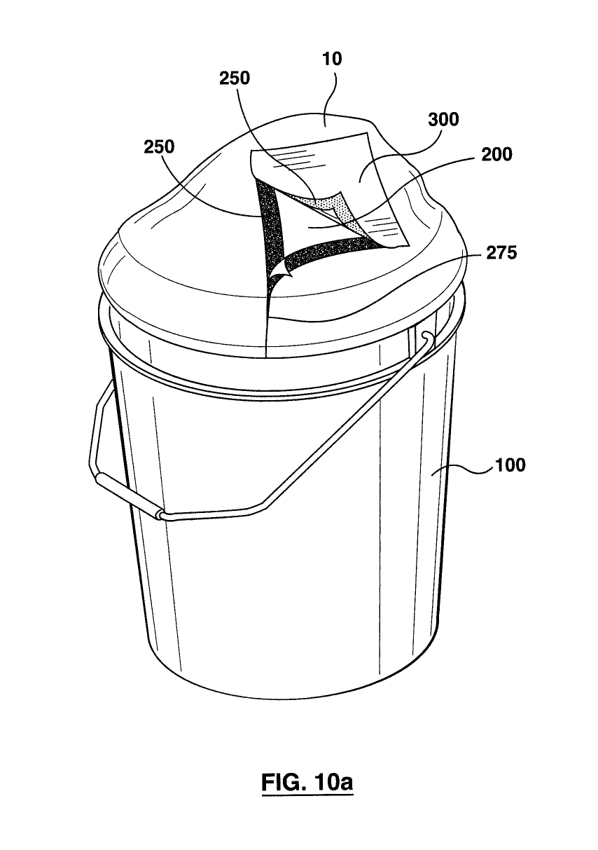

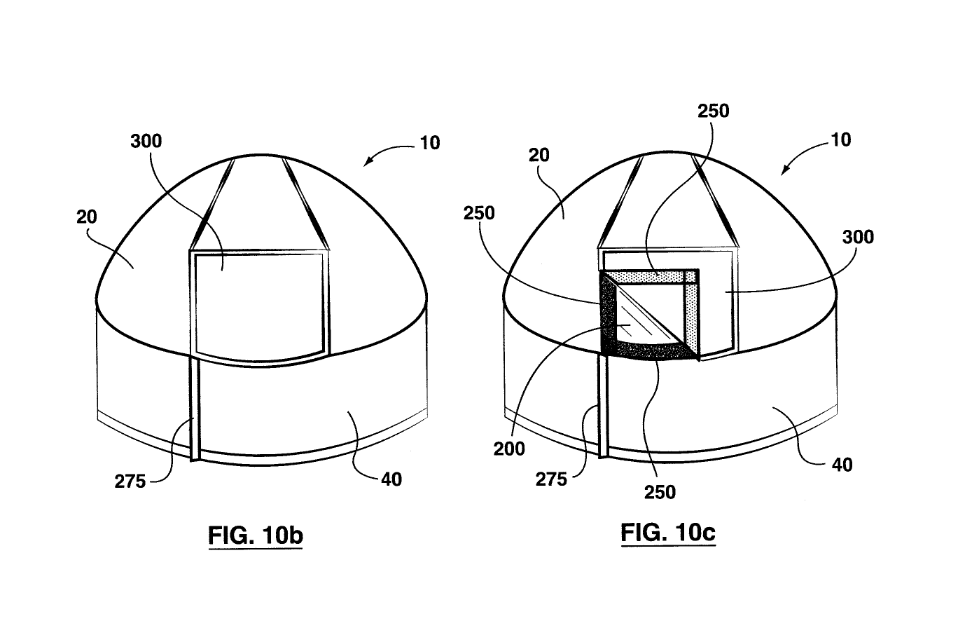

FIGS. 10a-c depict a further embodiment of the current invention wherein one or more of the first surface 22 or sheets 26 may contain an aperture 200 that may be releasably sealed by a flap 300 sized and oriented so that when closed, the cover 10 maintains its substantially air-tight connection to the paint container 100. Preferably, the aperture 200 is also sized to accommodate painting tools such as components of mechanical paint sprayers that are inconvenient to assemble and disassemble when a user wishes to temporarily suspend use, but are too large to be accommodated within the volume created by the combination of the paint container 100 and the cover 10. The peripheral edge of the flap 300 and the opposing surface of the first surface 22 or sheets 26 proximate the aperture are advantageously equipped with compatible means for securing the flap to the cover 10. In this instance, the means for securing the flap 300 and the cover 10 is corresponding hook and loop strips 250, but it will be appreciated by those in the art that there are alternate means for releasably fastening the flap 300 to the cover 10, including but not limited to zippers, releasable adhesive surfaces, or snaps. FIG. 10b depicts the flap 300 in a closed position creating a substantial seal, while FIG. 10c depicts the flap 300 in a partially open state.

FIGS. 10a-c also depict one variation of the embodiment wherein the first surface 22 or the sheets 26 where the aperture 200 exists, further contains a seam 275 joining the aperture 200 to the distal edge 42 of the band 40. Preferably, the edges of the seam 275 are configured to be releasably secured to each other. As will be appreciated by one skilled in the art, this can be accomplished by various well known means such as, for example, proportioning the seam edges to overlap thereby providing opposing surfaces for hook and loop strips, or inserting a zippered edge, all versions of which are intended to fall within the scope of this invention. The optional presence of a sealable seam 275 allows a user to connect the cover 10 to a paint container 100 while components of a large paint tool such as a mechanical sprayer are inserted in the paint container 100 without having to thread the components through the aperture 200, thereby avoiding the potential for spills and a mess. To install the cover 10 in these circumstances, the user simply secures the band 40 to the upper edge of the paint container 100 with the seam 275 proximate to where the painting tool is protruding from the paint container 100 and the aperture 200 accommodating the painting tool handle, secures the opposing edges of the seam 275 from the band 40 to the aperture 200, and substantially seals the flap 300 around the protruding components of the large painting tool.

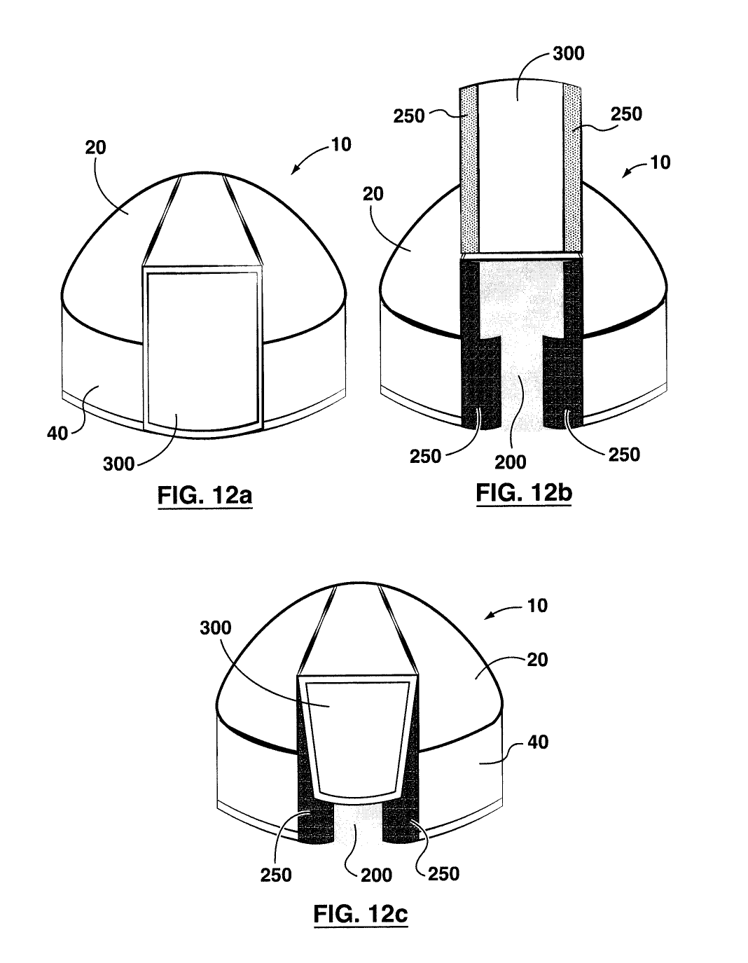

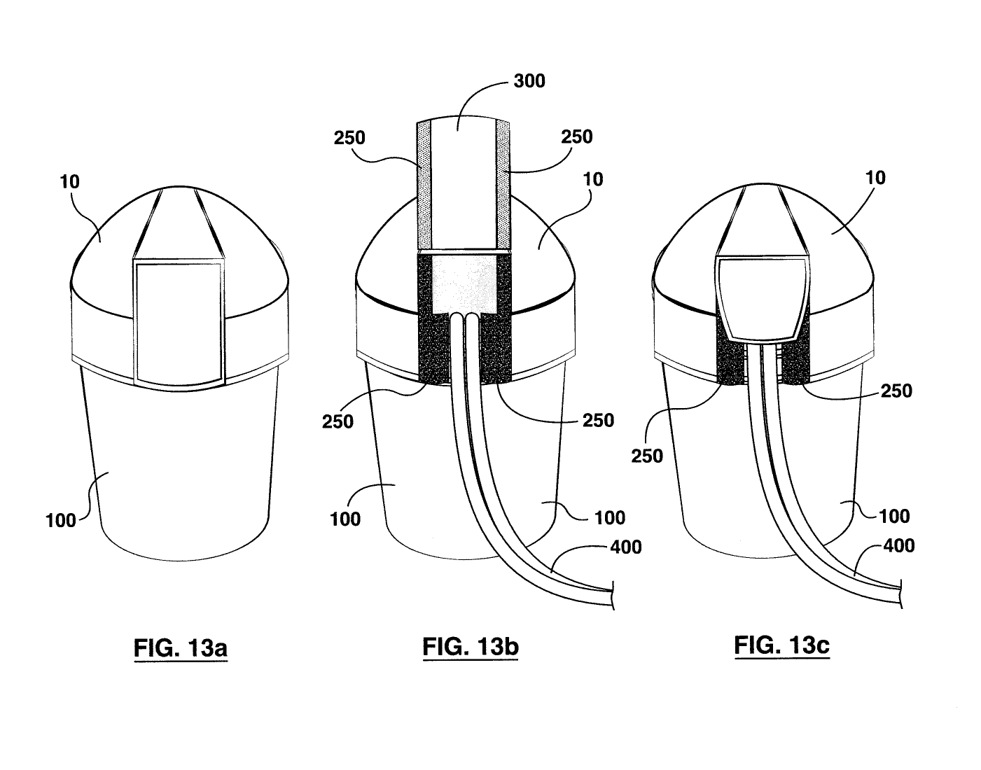

FIGS. 12a-c and 13a-c depict a further embodiment of the invention whereby the aperture 200 and the flap 300 each extend to the distal edge 42 of the band 40. Specifically referring to FIGS. 12b and 12c, it can be seen that in this embodiment it is advantageous to provide a hook and loop surface 250 on one of the first surface 22 or sheets 26 adjacent the aperture 200, such that the hook and loop surface 250 is proportioned to accommodate bulging of the flap 300 as it bends to accommodate a protruding painting tool, while still engaging with the corresponding hook or loop surface 250 on the underside of the flap 300. An exemplary embodiment is shown in FIG. 12b where the hook or loop surfaces 250 connected to the one of the first surface 22 or sheets 26 and band 40 are substantially L-shaped and reverse-L-shaped adjacent to the aperture 200, but it will be appreciated that many other configurations are suitable to accomplish this and are intended to be within the scope of this invention. The hook or loop surface 250 may extend over the exterior surface and to the distal edge 42 of the band 40 in this or any other embodiment containing a seam 275 or a fastening mechanism 50 comprising mating hook and loop surfaces 250. FIGS. 13a-c respectively depict the embodiment of FIGS. 12a-c connected to a paint container 100 with the flap 300 in a closed position with no paint tool, in an open position with a paint tool 400 protruding through the aperture 200, and in a closed position with a protruding paint tool 400 and the flap 300 deformed to accommodate the paint tool 400 while allowing the mating hook and loop surfaces 250 to engage, creating a substantially air-tight configuration on the paint container 100.

Preferably, the panel 20 and band 40 are made from one or more segments of flexible, air-impermeable plastic, such as polyvinyl chloride that may be connected by any known means such as stitching, heat bonding or gluing. Alternatively, one or more portions of the panel 20 or the band 40 may be formed from rigid materials, such as vinyl or polypropylene, and may be formed by any convention means such as injection molding, vacu-forming or thermoforming. Preferences for materials or manufacturing process set forth herein, however, do not limit the scope of the invention.

Optionally, the invention may include additional accessory modules attached to the cover 10. These accessory modules may include items such as brush holsters, rag storage, and screwdriver holders, and may further be themselves fixably attached or detachable. It will also be appreciated that the panel 20 of the present invention represents a convenient surface for graphic materials, instructions and advertising content.

The combination of elements of the present invention comes together to store painting tools in a substantially air-tight manner within a paint container 100. In all the embodiments disclosed, to use the cover 10 of the present invention, a paint container 100 is covered with the cover 10 having elements as previously described. Once the cover 10 is in place covering the container opening, the band 40 is cinched into a substantially air-tight configuration by closing the fastening mechanism 50 and thus holding the band 40 tightly against the paint container 100. After the cover 10 is sealed in place, a handle of at least one painting tool such as a paint brush handle 120 or paint roller handle 110 may be engaged with or restrained by the at least one tool holder 30. The tool holder 30 snugly grips, restrains or envelopes the tool handle to hold it in place and to further contribute to the air-tightness of the cover 10.

It will be understood that the specification is illustrative of the present invention and that other embodiments within the spirit and scope of the invention will suggest themselves to those skilled in the art. Specific examples set forth in the description are not intended to limit the scope of the invention. While the foregoing provides certain non-limiting example embodiments, it should be understood that combinations, subsets, and variations of the foregoing are contemplated. The monopoly sought is defined by the claims.

In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claim.

1. A paint container cover for a paint container comprising:
a panel, the panel having a first surface and a continuous edge, the first surface having at least one tool holder;
a band connected to the continuous edge, the band having a distal edge;
wherein the band is releasably connectable to the paint container creating a substantially air-tight configuration within the paint container.

2. A paint container cover of claim 1 wherein the at least one tool holder comprises an aperture sized to accommodate a painting tool.

3. A paint container cover of claim 2 wherein the panel comprises a flap, the flap being sized to cover the aperture, wherein the flap and the panel are releasably connectable to form a substantially air impermeable surface in a closed position or accommodate a painting tool in a partially closed or open position.

4. A paint container of claim 3 wherein a seam connects the aperture with the distal edge of the band, the seam being releasably sealable.

5. A paint container of claim 3 wherein the aperture extends to the distal edge of the band.

6. A paint container cover of claim 2 wherein the at least one tool holder comprises a sleeve.

7. A paint container cover of claim 1 wherein the band comprises a fastening mechanism.

8. A pain container of claim 1 wherein the distal edge of the band is configured to mate with the edge of the paint container.

9. A paint container cover of claim 1 wherein the panel comprises one or more sheets connected to the first surface and the continuous edge, and wherein the panel forms a substantially air impermeable surface that is configured to enclose a volume capable of accommodating a painting tool when the pain container cover is attached to the paint container.

10. A paint container of claim 1 wherein the band or the panel comprise one or more accessory modules.
